(19) United States
(12) Patent Application Publication
(10) Pub. No.: US 2019/0122567 A1
(43) Pub. Date: Apr. 25, 2019

(54) UNMANNED AERIAL VEHICLE FLIGHT MANAGEMENT

(71) Applicant: Skyward IO, Inc., Portland, OR (US)

(72) Inventor: Jonathan EVANS, Portland, OR (US)

(21) Appl. No.: 15/790,461

(22) Filed: Oct. 23, 2017

(51) Int. Cl. G08G 5/00; B64C 39/02

(52) U.S. Cl. CPC G08G 5/0069; G08G 5/0039; B64C 2201/146; G08G 5/006; B64C 39/024; G08G 5/0034

(57) ABSTRACT

A device can be configured to receive a flight request including at least one flight characteristic for an unmanned aerial vehicle (UAV) flight; identify flight characteristics associated with the flight request; identify a flight guideline associated with the flight request, the flight guideline specifying a limitation for an identified flight characteristic; determine, based on the flight guideline, that one of the identified flight characteristics is a questionable flight characteristic; and/or perform an action based on the questionable flight characteristic.

### BACKGROUND

Unmanned aerial vehicles (UAVs) are often operated in a variety of areas, by a variety of users, and for a variety of purposes. Whether a UAV pilot flies a UAV can depend on a variety of rules and regulations relevant to the planned UAV flight as well as the pilot's considerations regarding the planned flight.

### BRIEF DESCRIPTION OF THE DRAWINGS

FIG. 1 is a diagram of an overview of an example implementation described herein;

FIG. 2 is a diagram of an example environment in which systems and/or methods, described herein, can be implemented;

FIG. 3 is a diagram of example components of one or more devices of FIG. 2;

FIG. 4 is a flow chart of an example process for unmanned aerial vehicle flight management; and

FIG. 5 is a diagram of an example implementation relating to the example process shown in FIG. 4.

### DETAILED DESCRIPTION OF PREFERRED EMBODIMENTS

The following detailed description of example implementations refers to the accompanying drawings. The same reference numbers in different drawings can identify the same or similar elements.

An unmanned aerial vehicle (UAV) user, such as a UAV pilot, might request permission to fly a UAV in a given situation. Various guidelines can affect whether the UAV can be flown in the given situation, including various government guidelines and organizational guidelines. A typical flight approval process can be slow, subject to errors and inconsistencies, and potentially risky. For example, an individual might obtain incomplete or erroneous guidelines and use incomplete or erroneous flight data to determine whether a flight is to be approved, and the decisions made by one individual can be different from another individual in the same situation.

Some implementations, described herein, provide a flight management device to identify various flight characteristics associated with a flight request, such as information identifying a user, an aircraft, and airspace characteristics, and use guidelines and flight characteristics to determine whether a UAV can or should be flown in a given situation. For example, the flight management device can analyze the flight characteristics in light of the guidelines to determine whether each of the flight characteristics is acceptable, unacceptable, or questionable. An acceptable flight characteristic can include a flight characteristic that satisfies the guideline(s). An unacceptable flight characteristic can include a flight characteristic that fails to satisfy the guideline(s). A questionable flight characteristic can include a flight characteristic that satisfies the guideline(s) but is close to, such as within a certain degree, measure, or percentage of, failing to satisfy the guideline(s), a flight characteristic that fails to satisfy the guideline(s) but is close to, such as within a certain degree, measure, or percentage of, satisfying the guideline(s), or the like.

In a situation where a certain flight characteristic is identified as a questionable flight characteristic (e.g., when current wind speed is close to a maximum wind speed guideline), the flight management device can take action in a manner designed to address potential risks associated with the questionable flight characteristic. An example of an action that can be taken by the flight management device can include notifying the user or a third party of potential risks, requesting user or third party approval to fly, and/or suggesting changes to a proposed flight plan.

In some implementations, the flight management device can monitor flight characteristics for a UAV flight in progress and take action based on a change in flight characteristics. For example, in response to wind speed meeting a threshold wind speed specified by a flight guideline, the flight management device can take action, such as notifying the UAV user of the change in wind speed or causing the UAV to land or change course.

Some implementations described herein facilitate UAV flight plan approval by using a flight management device to automatically check characteristics of a proposed flight against guidelines that affect the proposed flight, which can increase the speed, efficiency, accuracy, and uniformity of flight plan approval relative to approval processes using manual guideline acquisition and flight characteristic comparison. Faster and more uniform flight approval can lead to improved user experience, more efficient flight approval can free up organizational resources that might otherwise be devoted to more resource intensive flight approval processes, and more accurate flight approval can lead to an improved user experience and safer flights.

Some implementations of the flight management device described herein can address risks associated with UAV flights and improve airspace and ground safety relative to manual flight plan approval processes by automatically informing the UAV user of potential risks, suggesting flight plans that might be safer and/or more efficient than originally submitted flight plans, updating the UAV user to changing flight conditions, and/or taking direct control of a UAV in certain circumstances. In addition, some implementations of the flight management device described herein facilitate configurable risk management of UAV flights at an organizational level, e.g., allowing an organization to set customized guidelines for various flight characteristics and allow approval of different characteristics by different parties.

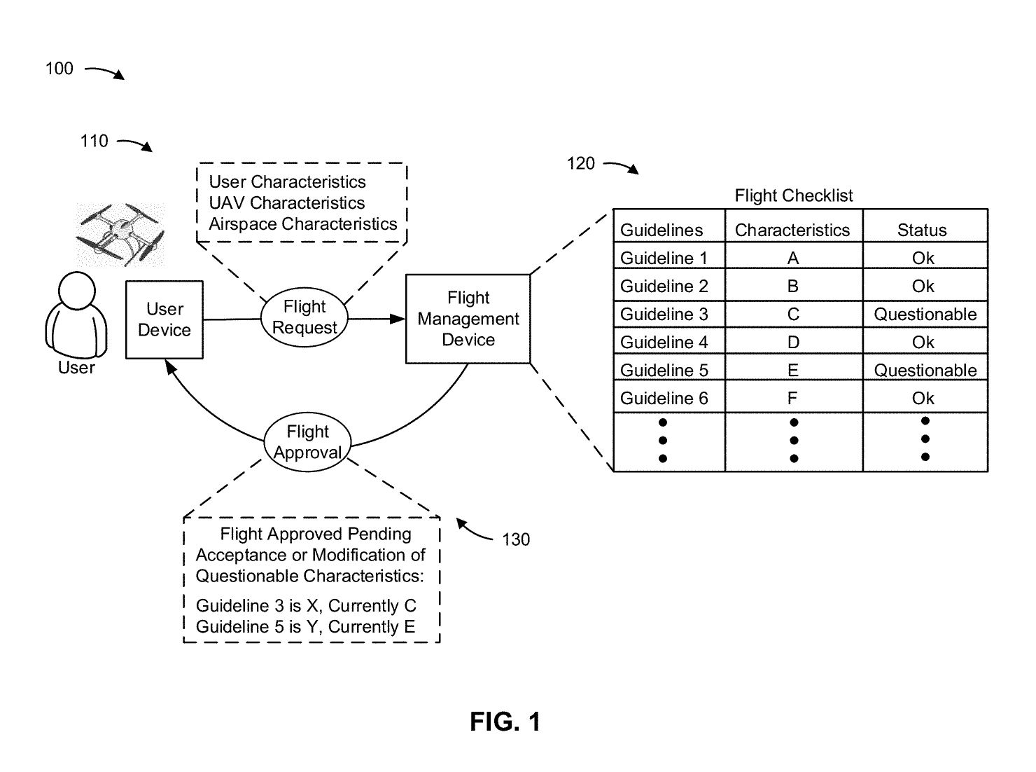

FIG. 1 is a diagram of an overview of an example implementation 100 described herein. As shown in FIG. 1, example implementation 100 can include a user device and a flight management device.

As shown in FIG. 1, and by reference number 110, a user can use the user device to submit a flight request to the flight management device. The flight request can include a variety of information relating to the requested flight, such as user characteristics (e.g., user identifier, pilot certification(s), etc.), UAV characteristics (e.g., UAV model number, UAV range, etc.), or airspace characteristics (e.g., wind speed information, visibility information, etc.). The information included in the flight request can come from a variety of sources. For example, a user might enter some or all of the information, such as the user identifier or the visibility information, sensors on the user device or UAV can provide some or all of the information, such as wind speed measurements, UAV model number, or UAV range, and/or an application on the user device can provide information calculated by or previously gathered by the user device, such as a timestamp indicating flight time, a proposed flight plan, or a calculated flight duration.

As further shown in FIG. 1, and by reference number 120, the flight management device builds a flight checklist for the flight request. The flight checklist can be built by identifying any additional flight characteristics not included in the flight request, identifying guidelines relevant to the flight request based on the characteristics provided by the flight request and/or any other flight characteristics, and determining whether the flight characteristics satisfy the identified guidelines.

For example, the flight management device can identify a guideline for minimum visibility, e.g., from a local government regulation that specifies UAVs should not be flown in conditions with less than 2 kilometers of visibility. Given this example guideline, in a situation where the current visibility is 6 kilometers, the flight management device can flag the minimum visibility guideline in the checklist as acceptable. As another example, the flight management device might identify a pilot licensing guideline that specifies that the user is permitted to fly a UAV in wind speeds no greater than 30 kilometers per hour (“kph”). In a situation with a wind speed of 25 kph, the flight management device can determine that the current wind speed characteristic of 25 kph satisfies the 30 kph guideline but is nevertheless questionable, and flag the guideline as such in the flight checklist. The determination that the wind speed characteristic is questionable can be made, for example, because the current wind speed characteristic of 25 kph is within a certain degree, measure, or percentage of satisfying the 30 kph guideline.

As also shown in FIG. 1, and by reference number 130, the flight management device provides flight approval data to the user device. The flight approval data indicates that the flight can be approved pending the user's acceptance or modification of questionable characteristics C and E. Characteristic C, for example, might be the wind speed of 25 kph, and while guideline 3 might indicate the pilot is rated for up to 30 kph, the determination that the wind speed is questionable allows the user to make an informed decision regarding whether the flight should proceed. As another example, characteristic E might be a UAV flight time of 85% of the maximum flight time for that UAV, and guideline 5 might be an insurance regulation specifying that the proposed flight time should be no greater than 90% of the maximum UAV flight time. In this situation, the user can make an informed decision to cancel the flight, proceed with the flight as is, or change the UAV being used to one with a greater maximum flight time.

Accordingly, the example implementation 100 depicts a UAV flight management process that can increase the speed, efficiency, accuracy, and uniformity of flight plan approval relative to approval processes using manual guideline acquisition and flight characteristic evaluation, e.g., by using a flight management device to identify relevant flight characteristics and guidelines, evaluate those characteristics in light of the guidelines, and provide a user with questionable flight characteristics to review prior to, or during, a UAV flight. Faster and more uniform flight approval can lead to improved user experience, more efficient flight approval can save organizational resources that might otherwise be devoted to more resource intensive flight approval processes, and more accurate flight approval can lead to an improved user experience and safer flights.

As indicated above, FIG. 1 is provided merely as an example. Other examples are possible and can differ from what was described with regard to FIG. 1.

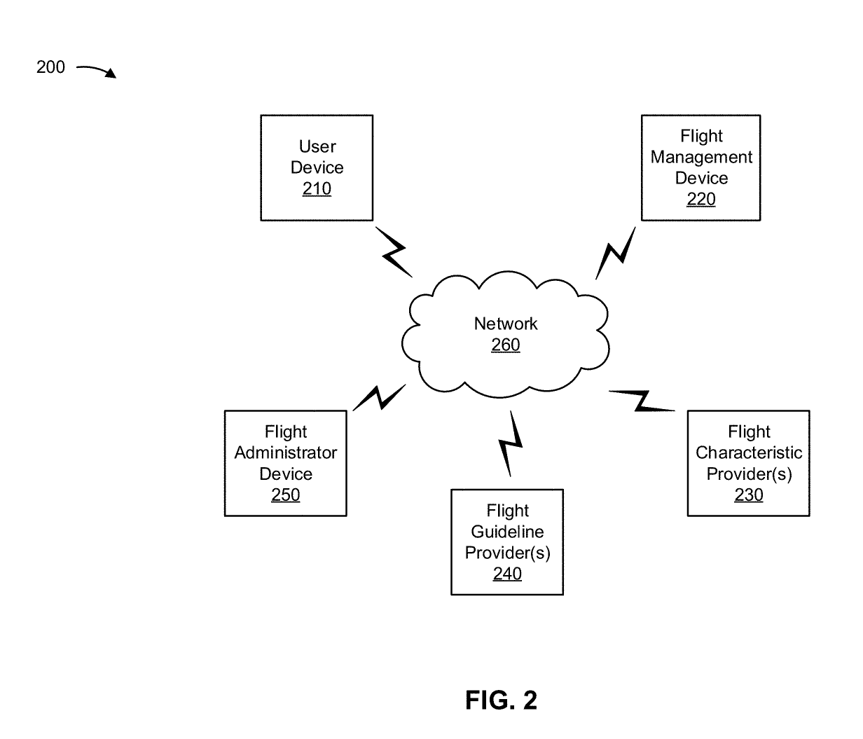

FIG. 2 is a diagram of an example environment 200 in which systems and/or methods, described herein, can be implemented. As shown in FIG. 2, environment 200 can include a user device 210, a flight management device 220, a flight characteristic provider(s) 230, a flight guideline provider(s) 240, a flight administrator device 250, and a network 260. Devices of environment 200 can interconnect via wired connections, wireless connections, or a combination of wired and wireless connections.

User device 210 includes one or more devices capable of receiving, generating, storing, processing, and/or providing information associated with UAV flight requests. For example, user device 210 can include a communication and/or computing device, such as a mobile phone (e.g., a smart phone, a radiotelephone, etc.), a laptop computer, a tablet computer, a handheld computer, a gaming device, a wearable communication device (e.g., a smart wristwatch, a pair of smart eyeglasses, etc.), or a similar type of device. In some implementations, user device 210 can include an input device or peripheral for providing input, such as a touch screen display, keyboard, or microphone, e.g., for inputting flight characteristics. Additionally, or alternatively, user device 210 can include a UAV remote control device or other UAV equipment in communication with a UAV. User device 210 can, in some implementations, include a communications interface that allows the user device 210 to receive information from and/or transmit information to flight management device 220 and/or flight characteristic provider(s) 230. For example, user device 210 can transmit a flight request to flight management device 220 and/or receive a flight characteristic from flight characteristic provider(s) 230.

Flight management device 220 includes one or more devices capable of receiving, generating, storing, processing, and/or providing information associated with UAV flights, flight characteristics, and/or flight guidelines. For example, flight management device 220 can include a communication and/or computing device, such as a server device or a group of server devices. In some implementations, flight management device 220 can be implemented by one or more computing devices of a cloud computing environment or a data center. In some implementations, flight management device 220 can correspond to user device 210. In other words, flight management device 220 and user device 210 can be implemented within the same device or group of devices. In some implementations, flight management device 220 can include a communications interface that allows the flight management device 220 to receive information from and/or transmit information to user device 210, flight characteristic provider(s) 230, flight guideline provider(s) 240, and/or flight administrator device 250. For example, flight management device 220 can receive a flight request from user device 210, receive flight characteristics from flight characteristic provider(s) 230, receive flight guidelines from flight guideline provider(s) 240, and/or transmit flight approval data to user device 210 and/or flight administrator device 250.

Flight characteristic provider(s) 230 includes one or more devices capable of receiving, generating, storing, processing, and/or providing information associated with flight characteristics. For example, flight characteristic provider(s) 230 can include a communication and/or computing device, such as a server device or a group of server devices. Other example flight characteristic provider(s) 230 can include a UAV, a UAV sensor, or another UAV component. Flight characteristic provider(s) 230 can, in some implementations, include a communications interface that allows the flight characteristic provider(s) 230 to receive information from and/or transmit information to user device 210 and/or flight management device 220. For example, flight characteristic provider(s) 230 can transmit a flight characteristic to user device 210 and/or flight management device 220.

Flight guideline provider(s) 240 includes one or more devices capable of receiving, generating, storing, processing, and/or providing information associated with flight guidelines. For example, flight guideline provider(s) 240 can include a communication and/or computing device, such as a server device or a group of server devices. Flight guideline provider(s) 240 can, in some implementations, include a communications interface that allows the flight guideline provider(s) 240 to receive information from and/or transmit information to flight management device 220. For example, flight guideline provider(s) 240 can transmit a flight guideline to flight management device 220.

Flight administrator device 250 includes one or more devices capable of receiving, generating, storing, processing, and/or providing information associated with UAV flight requests and flight approval data. For example, flight administrator device 250 can include a communication and/or computing device, such as a mobile phone (e.g., a smart phone, a radiotelephone, etc.), a server device, a personal computer, a laptop computer, a tablet computer, a handheld computer, a gaming device, a wearable communication device (e.g., a smart wristwatch, a pair of smart eyeglasses, etc.), or a similar type of device. The flight administrator device 250 can, in some implementations, include a communications interface that allows the flight administrator device 250 to receive information from and/or transmit information to user device 210 and/or flight management device 220. For example, flight administrator device 250 can receive flight approval data from flight management device 220 and/or transmit flight approval data to user device 210.

Network 260 includes one or more wired and/or wireless networks. For example, network 260 can include a cellular network (e.g., a long-term evolution (LTE) network, a code division multiple access (CDMA) network, a 3G network, a 4G network, a 5G network, another type of next generation network, etc.), a public land mobile network (PLMN), a local area network (LAN), a wide area network (WAN), a metropolitan area network (MAN), a telephone network (e.g., the Public Switched Telephone Network (PSTN)), a private network, an ad hoc network, an intranet, the Internet, a fiber optic-based network, a cloud computing network, or the like, and/or a combination of these or other types of networks.

The number and arrangement of devices and network shown in FIG. 2 are provided as an example. In practice, there can be additional devices and/or networks, fewer devices and/or networks, different devices and/or networks, or differently arranged devices and/or networks than those shown in FIG. 2. Furthermore, two or more devices shown in FIG. 2 can be implemented within a single device, or a single device shown in FIG. 2 can be implemented as multiple, distributed devices. Additionally, or alternatively, a set of devices (e.g., one or more devices) of environment 200 can perform one or more functions described as being performed by another set of devices of environment 200.

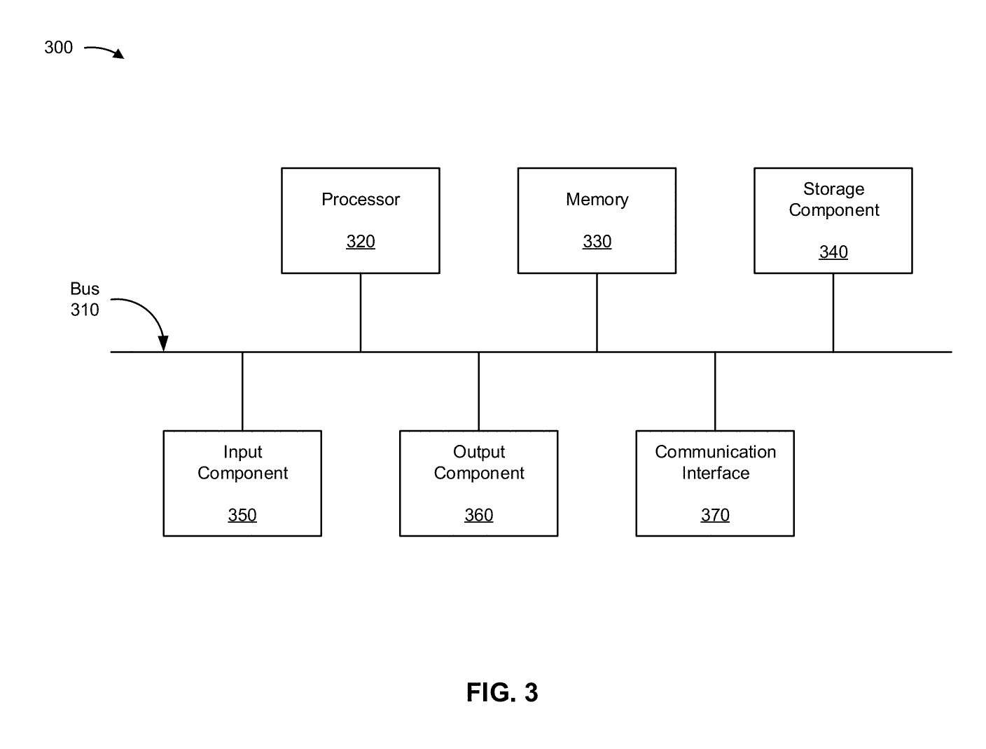

FIG. 3 is a diagram of example components of a device 300. Device 300 can correspond to user device 210, flight management device 220, flight characteristic provider 230, flight guideline provider 240, and/or flight administrator device 250. In some implementations, user device 210, flight management device 220, flight characteristic provider 230, flight guideline provider 240, and/or flight administrator device 250 can include one or more devices 300 and/or one or more components of device 300. As shown in FIG. 3, device 300 can include a bus 310, a processor 320, a memory 330, a storage component 340, an input component 350, an output component 360, and a communication interface 370.

Bus 310 includes a component that permits communication among the components of device 300. Processor 320 is implemented in hardware, firmware, or a combination of hardware and software. Processor 320 is a central processing unit (CPU), a graphics processing unit (GPU), an accelerated processing unit (APU), a microprocessor, a microcontroller, a digital signal processor (DSP), a field-programmable gate array (FPGA), an application-specific integrated circuit (ASIC), or another type of processing component. In some implementations, processor 320 includes one or more processors capable of being programmed to perform a function. Memory 330 includes a random access memory (RAM), a read only memory (ROM), and/or another type of dynamic or static storage device (e.g., a flash memory, a magnetic memory, and/or an optical memory) that stores information and/or instructions for use by processor 320.

Storage component 340 stores information and/or software related to the operation and use of device 300. For example, storage component 340 can include a hard disk (e.g., a magnetic disk, an optical disk, a magneto-optic disk, and/or a solid state disk), a compact disc (CD), a digital versatile disc (DVD), a floppy disk, a cartridge, a magnetic tape, and/or another type of non-transitory computer-readable medium, along with a corresponding drive.

Input component 350 includes a component that permits device 300 to receive information, such as via user input (e.g., a touch screen display, a keyboard, a keypad, a mouse, a button, a switch, and/or a microphone). Additionally, or alternatively, input component 350 can include a sensor for sensing information (e.g., a global positioning system (GPS) component, an accelerometer, a gyroscope, and/or an actuator). Output component 360 includes a component that provides output information from device 300 (e.g., a display, a speaker, and/or one or more light-emitting diodes (LEDs)).

Communication interface 370 includes a transceiver-like component (e.g., a transceiver and/or a separate receiver and transmitter) that enables device 300 to communicate with other devices, such as via a wired connection, a wireless connection, or a combination of wired and wireless connections. Communication interface 370 can permit device 300 to receive information from another device and/or provide information to another device. For example, communication interface 370 can include an Ethernet interface, an optical interface, a coaxial interface, an infrared interface, a radio frequency (RF) interface, a universal serial bus (USB) interface, a Wi-Fi interface, a cellular network interface, or the like.

Device 300 can perform one or more processes described herein. Device 300 can perform these processes based on processor 320 executing software instructions stored by a non-transitory computer-readable medium, such as memory 330 and/or storage component 340. A computer-readable medium is defined herein as a non-transitory memory device. A memory device includes memory space within a single physical storage device or memory space spread across multiple physical storage devices.

Software instructions can be read into memory 330 and/or storage component 340 from another computer-readable medium or from another device via communication interface 370. When executed, software instructions stored in memory 330 and/or storage component 340 can cause processor 320 to perform one or more processes described herein. Additionally, or alternatively, hardwired circuitry can be used in place of or in combination with software instructions to perform one or more processes described herein. Thus, implementations described herein are not limited to any specific combination of hardware circuitry and software.

The number and arrangement of components shown in FIG. 3 are provided as an example. In practice, device 300 can include additional components, fewer components, different components, or differently arranged components than those shown in FIG. 3. Additionally, or alternatively, a set of components (e.g., one or more components) of device 300 can perform one or more functions described as being performed by another set of components of device 300.

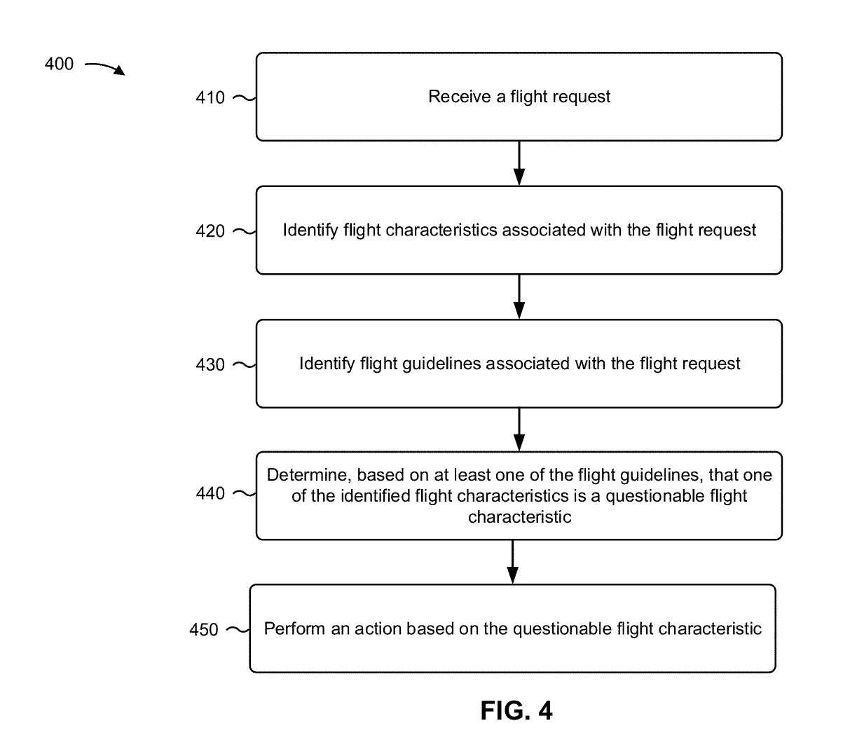

FIG. 4 is a flow chart of an example process 400 for UAV flight management. In some implementations, one or more process blocks of FIG. 4 can be performed by flight management device 220. In some implementations, one or more process blocks of FIG. 4 can be performed by another device or a group of devices separate from or including flight management device 220, such as user device 210, flight characteristic provider 230, flight guideline provider 240, and/or a flight administrator device 250.

As shown in FIG. 4, process 400 can include receiving a flight request (block 410). In some implementations, flight management device 220 can receive a flight request from user device 210. For example, a user of user device 210 might provide input that causes user device 210 to provide a flight request, e.g., for the purpose of obtaining approval for a flight associated with the flight request. The flight request can indicate, include, or specify a variety of flight characteristics regarding the flight associated with the flight request. Example flight characteristics include: flight date, flight time, flight duration, flight altitude, flight origin location, flight destination location, flight path, wind speed, humidity, temperature, precipitation, visibility, sunset time, UAV model number, UAV flight ceiling, UAV weight, UAV maximum payload, UAV maximum wind speed, UAV maximum operating temperature, UAV minimum operating temperature, UAV maximum communication range, UAV maximum flight duration, UAV maximum speed, UAV noise level (e.g., in terms of noise generated by the UAV), pilot certifications, pilot maximum operating wind speed (e.g., a maximum wind speed in which a pilot is licensed to fly), pilot maximum flight operating duration (e.g., a time limit in minutes, hours, etc. for a pilot to control a UAV in the air), pilot minimum operating visibility (e.g., a minimum visibility in which a pilot is licensed to fly), pilot maximum operating range (e.g., in terms of a maximum measure of distance between pilot and UAV at which a pilot is licensed to fly and/or whether a pilot is licensed to operate a UAV outside of line of sight), most recent pilot flight (e.g., hours, days, etc. since last UAV flight piloted), and/or career pilot hours (e.g., total hours flown by a pilot in a particular UAV and/or all UAVs).

Flight characteristics can be expressed using a variety of units of measure, including units, percentages, ratios, or the like. For example, UAV maximum payload can be expressed as a particular unit of measurement, such as 5 kilograms, or can be expressed as a percentage of UAV weight, such as 10% of a UAV's weight. As another example, flight origin location can specify a particular city and/or county, and/or can be expressed using a street address and/or geographic coordinates.

In some implementations, flight characteristics specified by a flight request can be provided by a user of user device 210, e.g., the user can input a flight origin location and a flight destination location to user device 210. In some implementations, user device 210 can provide, in the flight request, flight characteristics that were not provided by the user for the flight request, e.g., a flight characteristic stored on user device 210, obtained from a sensor of user device 210, and/or obtained from a separate device. For example, user device 210 can obtain a user identifier from a local hard disk, a temperature measurement from a sensor of user device 210, a wind speed measurement from a UAV in communication with user device 210, and/or a visibility measurement from a weather data server. User device 210 can include, in the flight request provided to flight management device 220, some, none, or all of the flight characteristics available to user device 210. At least some of the flight characteristics included in the flight request can facilitate the identification of other flight characteristics or flight guidelines that can be used to approve or deny the proposed flight.

In this way, flight management device 220 can receive a flight request to enable flight management device 220 to identify other flight characteristics and/or flight guidelines that can be used to approve or deny a flight associated with the flight request.

As further shown in FIG. 4, process 400 can include identifying flight characteristics associated with the flight request (block 420). For example, flight management device 220 can identify flight characteristics included in a flight request that was provided by user device 210, e.g., the flight request can specify a flight origin location, flight destination location, flight time, user identifier, wind speed, or the like.

In some implementations, flight management device 220 can identify a flight characteristic by obtaining the flight characteristic from a source other than the flight request. Any number of flight characteristics can be obtained from any number of sources. For example, flight management device 220 can obtain a flight characteristic from user input provided to flight management device 220, from a local or remote storage device, from flight characteristic provider(s) 230, and/or from user device 210. By way of example, flight management device 220 can obtain information associated with a flight path from user input, a record of a pilot's most recent flight from a local storage device, a wind speed measurement from a remote weather data server, a pilot maximum operating wind speed from a remote pilot license data server, a UAV maximum payload from a remote UAV data server, and/or a pilot license number from user device 210.

In some implementations, flight management device 220 can identify a flight characteristic based on a flight request. For example, flight management device 220 can identify flight characteristics in response to receiving a flight request. A flight characteristic identified from one flight request might vary from a flight characteristic identified for another flight request, e.g., by varying which flight characteristic(s) is/are identified and/or varying flight characteristic provider(s) 230 used to obtain the characteristic(s).

In some implementations, flight management device 220 can identify a flight characteristic periodically, or based on an occurrence of a triggering event. For example, flight management device 220 can periodically obtain temperature and wind speed measurements from flight characteristic provider(s) 230. As another example, flight management device 220 can obtain a wind speed measurement from a UAV based on receiving, from a weather data server, a wind speed measurement that satisfies a threshold wind speed. Periodic identification of a flight characteristic can vary, e.g., whether periodic measurements are gathered for the flight characteristic and/or how often the flight characteristic is identified. Events that trigger identification of a flight characteristic can also vary, e.g., by varying a triggering event or flight characteristic evaluated against the triggering event, varying a trigger threshold, and/or varying flight characteristic provider(s) 230 from which the flight characteristic is obtained. Variations in flight characteristic identification methods and/or events that trigger identification of a flight characteristic can be made in a variety of ways, e.g., according to a given flight management device 220 configuration and/or user input.

In some implementations, flight management device 220 can identify a flight characteristic based on another flight characteristic. For example, flight management device 220 can use a user identifier included in a flight request to obtain a pilot license associated with that user identifier in a database. As another example, flight management device 220 can use the pilot license to request the minimum pilot operating visibility from a third party pilot license information server accessed via the Internet.

In some implementations, and as described in further detail below, identification of a flight characteristic can be performed based on a flight guideline. For example, a flight guideline might specify a maximum humidity level at which a UAV is rated to fly in, and flight management device 220 can identify a humidity characteristic based on the maximum humidity guideline.

In some implementations, multiple flight characteristics can be obtained from a single source, and/or multiple sources can provide the same flight characteristic. In a situation where multiple sources provide the same flight characteristic (e.g., two different wind speed measurements, each from a different source), flight management device 220 can identify one wind speed measurement in a variety of ways, e.g., according to a predetermined source priority, or selecting a mean measurement, median measurement, or some other measurement derived from the provided measurements. For example, a user might specify, in the flight request, that the visibility is 3 kilometers, while a third party weather server might provide a visibility measurement of 4 kilometers. In a situation where flight management device 220 uses a priority system, flight management device 220 might select the visibility measurement of 4 kilometers provided by the third party weather service, e.g., assuming visibility measurements provided by the third party weather service have a higher priority than visibility measurements provided by a user of user device 210. In a situation where flight management device 220 uses a mean of both visibility measurements, flight management device 220 might select a visibility measurement of 3.5 kilometers (e.g., the mean of 3 kilometers and 4 kilometers).

In this way, flight management device 220 can identify flight characteristics to enable flight management device 220 to identify flight guidelines that can be used to approve or deny a flight associated with the flight request.

As further shown in FIG. 4, process 400 can include identifying flight guidelines associated with the flight request (block 430). For example, flight management device 220 can identify a flight guideline included in a data storage device or provided by flight guideline provider(s) 240, e.g., flight management device 220 can identify, in a data storage device, an organizational guideline created by an entity that operates flight management device 220.

A flight guideline can be a rule, regulation, principle, suggestion, instruction, advice, or the like, which is designed to establish one or more limitations for a UAV flight. Flight guidelines can come from a variety of sources. For example, flight guidelines can be provided by local, state, and/or federal governments, UAV pilot licensing organizations, UAV manufacturers, organizations affiliated with a UAV pilot (e.g., an organization that employs the UAV pilot, or an insurance organization that insures the UAV pilot and/or the UAV pilot's employer), and/or other entities having an interest in placing limitations on a UAV flight. By way of example, a local government guideline might be a regulation created by a local government, and the regulation might specify that a UAV should not be flown within the local government's jurisdictional airspace when wind speeds are greater than 50 kph.

A variety of flight guidelines can be identified by flight management device 220, and the flight guidelines can specify a variety of limitations for a UAV, UAV pilot, flight parameters, and/or airspace for a proposed UAV flight. Example flight guidelines include: a maximum UAV pilot operating duration, maximum flight operating altitude, maximum operating wind speed, minimum operating visibility, maximum UAV weight, restricted UAV model numbers, UAV maximum payload, UAV maximum noise level, restricted areas, or the like.

A flight guideline can, in some implementations, be associated with one or more flight characteristics, e.g., placing a limitation on one or more flight characteristics for a given UAV flight. For example, a UAV manufacturer guideline might be an instruction created by a UAV manufacturer, and the instruction might specify that a particular model of UAV has a maximum payload capacity of 5 kilograms. This example guideline places a limitation on a flight characteristic (UAV maximum payload) for any proposed UAV flight using the particular model of UAV.

Flight management device 220 can identify flight guidelines in a variety of ways. In some implementations, a flight guideline can be identified based on a flight request. For example, receiving a flight request can trigger identification of a predetermined set of flight guidelines. For example, flight management device 220 can obtain a UAV pilot license number for every flight request. In some implementations, flight management device 220 can identify a guideline based on one or more flight characteristics, such as guidelines relevant to flight characteristics included in the flight request and/or guidelines relevant to flight characteristics provided by flight characteristic provider(s) 230. For example, identifying flight origin location, flight destination location, and/or flight path characteristics in the flight request might cause flight management device 220 to identify government guidelines associated with the locations and/or the path specified by those characteristics.

In some implementations, a flight guideline can be stored and obtained from a data storage device, such as local or remote storage in communication with flight management device 220. For example, based on the receipt of a user identifier included in a flight request, flight management device 220 can obtain, from a database, one or more pilot license identifiers associated with the user identifier. In some implementations, a flight guideline can be obtained from flight guideline provider(s) 240. For example, based on receipt of a wind speed measurement from a weather data server, flight management device 220 can request and receive, from a UAV pilot licensing organization server, a guideline for a UAV pilot's maximum operating wind speed.

In some situations, multiple guidelines can specify limitations for the same flight characteristic. For example, a pilot licensing guideline might specify that a particular UAV pilot is licensed to fly a UAV in wind speeds up to 60 kph, a local government regulation might specify a maximum wind speed of 70 kph for a UAV flight in airspace under the local government's jurisdiction, a UAV manufacturer instruction might specify 80 kph as the maximum wind speed that a particular UAV should be flown in, an organization employing the particular UAV pilot might specify 50 kph as the maximum wind speed the particular UAV pilot should fly in, and an insurance company rule might specify that insurance covers flights up to the lowest maximum wind speed specified by any applicable pilot licensing and/or UAV manufacturer guideline.

In this way, flight management device 220 can identify flight guidelines to enable flight management device 220 to determine whether any flight characteristics are, in light of the identified guidelines, questionable.

As further shown in FIG. 4, process 400 can include determining, based on at least one of the flight guidelines, that one of the identified flight characteristics is a questionable flight characteristic (block 440). For example, a flight guideline might specify a limitation for a flight characteristic, and flight management device 220 can determine whether the corresponding flight characteristic is acceptable, unacceptable, or questionable, e.g., flight management device can determine that the corresponding flight characteristic is questionable based on the flight characteristic being close to, such as within a certain degree, measure, or percentage of, satisfying or failing to satisfy the flight guideline.

The manner in which flight management device 220 determines that an identified flight characteristic is questionable can vary. In some implementations, a numerical threshold can be used to determine whether an identified flight characteristic is questionable. By way of example, given a wind speed characteristic of 55 kph, a maximum wind speed guideline of 60 kph, and a questionability threshold of 10 kph, flight management device 220 can determine that the wind speed characteristic is questionable, e.g., because the wind speed of 55 kph is within 10 kph of the 60 kph guideline.

In some implementations, a measure of similarity or equivalence can be used to determine whether an identified flight characteristic is questionable. For example, a pilot certification guideline might specify that a UAV pilot have a first type of certification and the UAV pilot can have a second type of certification that is determined to be potentially equivalent to the first type; in this situation, flight management device 220 might determine that the UAV pilot license characteristic is questionable based on the second type of certification being potentially equivalent to the first type of certification.

Thresholds, measures of similarity, determinations of equivalence, or the like, which can be used by flight management device 220 to determine whether a flight characteristic is questionable, can be derived in a variety of ways. In some implementations, user input can be used to determine thresholds, measures of similarity, determinations of equivalence, or the like, e.g., a user can configure a wind speed threshold and identify various pilot licenses as equivalent or similar. In some implementations, mathematical formulae, models, and/or machine learning can be used to determine thresholds, e.g., a standard deviation can be used as a threshold for wind speed (based on previous wind speed measurements), and/or a visibility threshold can be determined and updated based on machine learning (e.g., using prior questionability determinations to adjust a threshold for identifying something as questionable, acceptable, or unacceptable).

In situations where multiple flight guidelines have been identified, flight management device 220 can determine whether a flight characteristic is questionable based on one, some, or all of the identified flight guidelines. For example, questionability can be determined separately for each flight guideline, e.g., a wind speed measurement might be questionable for a UAV pilot licensing guideline, acceptable for a local government guideline, questionable for an organizational guideline, and acceptable for a UAV manufacturer guideline. As another example, questionability for a flight characteristic can be determined taking all flight guidelines related to that flight characteristic into account, e.g., a wind speed measurement might be determined to be questionable if it is questionable with respect to one wind speed guideline, even if it is acceptable under three other wind speed guidelines.

In some implementations, flight management device 220 can determine that a flight characteristic is questionable based on a source of a flight guideline. For example, an entity that controls flight management device 220 can determine that some flight guidelines do not need to be satisfied, and failing to meet those guidelines can cause a flight characteristic to be identified as questionable, rather than unacceptable. By way of example, an organization that employs UAV pilots can create its own wind speed guideline but determine that failing the guideline should cause the wind speed characteristic to be identified as questionable rather than unacceptable.

In some implementations, flight management device 220 can determine that a flight characteristic is questionable based on the flight characteristic itself, rather than the guideline. For example, an entity that controls flight management device 220 can determine that some flight characteristics should always be identified as questionable. By way of example, an organization that employs UAV pilots can cause flight management device 220 to always flag a visibility characteristic as questionable. Automatically flagging a characteristic as questionable can lead to more efficient use of computing resources, e.g., relative to using computing resources to analyze whether a characteristic is acceptable, unacceptable, or questionable.

In this way, flight management device 220 can determine that one of the flight characteristics is questionable, which can enable flight management device 220 to perform an action based on the questionable flight characteristic.

As further shown in FIG. 4, process 400 can include performing an action based on the questionable flight characteristic (block 450). For example, flight management device 220 can perform an action based on the questionable flight characteristic. Example actions can include: notifying user device 210 of the questionable flight characteristic, notifying flight administrator device 250 of the questionable characteristic, causing display of the questionable flight characteristic, causing a UAV to take an action, contacting flight characteristic provider(s) 230, another type of action, or a combination two or more of these actions.

In some implementations, flight management device 220 can send data identifying a questionable flight characteristic and/or a corresponding flight guideline to user device 210. The data can cause display of the questionable flight characteristic and/or corresponding flight guideline on a display of user device 210. For example, in a situation where wind speed is questionable, flight management device 220 can provide user device 210 with data that causes the wind speed characteristic and the corresponding wind speed guideline to be displayed on user device 210, e.g., flight management device 220 can send approval data (e.g., approving a flight associated with a flight request) that indicates a UAV flight is permitted pending approval, by a UAV pilot, of the questionable wind speed characteristic in view of the corresponding guideline. The foregoing example situation allows a UAV pilot to determine to proceed with a UAV flight despite the questionable wind speed, delay the UAV flight in light of the questionable characteristic, cancel the flight in light of the questionable characteristic, or take some other action, e.g., request an updated wind speed measurement using user device 210.

In some implementations, flight management device 220 can send data identifying a questionable flight characteristic and/or a corresponding flight guideline to flight administrator device 250. The data can cause display of the questionable flight characteristic and/or corresponding flight guideline on a display of flight administrator device 250. For example, a user of flight administrator device 250 might be a user responsible for making decisions regarding questionable flight characteristics, e.g., an organization that employs UAV pilots and uses UAV flights can have a user of flight administrator device 250 review and take action regarding a UAV flight based on a questionable flight characteristic.

By way of example, flight management device 220 can provide flight administrator device 250 with data that causes a wind speed characteristic and the corresponding wind speed guideline(s) to be displayed on flight administrator device 250, e.g., flight management device 220 can send approval data (e.g., approving a flight associated with a flight request) that indicates a UAV flight is permitted pending approval, by a user of flight administrator device 250, of the questionable wind speed characteristic in view of the corresponding guideline. The foregoing example situation allows a user of flight administrator device 250 to determine to proceed with a UAV flight despite the questionable wind speed, delay the UAV flight in light of the questionable characteristic, forward the approval and questionable characteristic to user device 210 for pilot approval, cancel the flight in light of the questionable characteristic, or take some other action, e.g., request an updated wind speed measurement using flight administrator device 250.

In some implementations, flight management device 220 can, based on a questionable flight characteristic, perform an action that affects a UAV. For example, flight management device 220 can communicate instructions to a UAV associated with a flight that is associated with the questionable flight characteristic, e.g., instructions can cause a UAV to be disabled or otherwise unable to fly, cause a UAV to change course, or cause a UAV to land. By way of example, based on a determination that a UAV pilot license characteristic is questionable, flight management device 220 can communicate instructions to a UAV to disable motors until the questionable flight characteristic is resolved.

In some implementations, flight management device 220 can, based on a questionable flight characteristic, obtain one or more flight characteristics. For example, in a situation where a wind speed characteristic is questionable, flight management device 220 can obtain another wind speed characteristic from flight characteristic provider(s) 230. In some implementations, a flight characteristic obtained based on a questionable flight characteristic can be used to confirm or separately determine whether the questionable flight characteristic should be identified as a questionable flight characteristic. For example, in a situation where a first wind speed characteristic is questionable, flight management device 220 can determine, using a second wind speed characteristic, whether the first wind speed characteristic should remain questionable, or if the first wind speed characteristic should be identified as acceptable or unacceptable.

In some implementations, flight management device 220 can, based on a questionable flight characteristic, perform periodic flight characteristic identification. For example, based on a wind speed characteristic being identified as questionable, flight management device 220 can periodically obtain a new wind speed measurement from flight characteristic provider(s) 230, e.g., in a manner designed to periodically confirm or change the questionability of the wind speed characteristic.

In some implementations, flight management device 220 can, based on a questionable flight characteristic, cause a meeting to be scheduled. For example, flight management device 220 can analyze and populate the calendars of parties having an interest in the UAV, a scheduled flight, a UAV pilot, a UAV pilot's supervisor, or the like. The parties might meet to discuss the questionable flight characteristic, the UAV, the scheduled flight, the UAV pilot, or the like.

In some implementations, flight management device 220 can, based on a questionable flight characteristic, cause an order to be placed for a UAV or a UAV part. For example, flight management device 220 can cause an order to be placed for a replacement UAV or a replacement UAV part that might render the questionable flight characteristic acceptable.

In some implementations, flight management device 220 can log data associated with process 400 and/or the questionable flight characteristics. For example, flight management device 220 can log information included in or about a flight request, identified flight characteristics, identified flight guidelines, determinations of questionability, and actions taken based on questionable flight characteristics. Logs can be used for a variety of purposes, including analysis of flights and machine learning, e.g., a threshold for determining whether a flight characteristic is questionable can be obtained or updated by using a machine learning model that uses past determinations of questionability.

In some implementations, flight management device 220 can determine an action to be performed, or can determine whether an action is to be performed, based on multiple, different questionable flight characteristics. For example, flight management device 220 can use a model to determine an action to be performed. The model can receive, as input, information identifying one or more questionable flight characteristics, and can output information indicating an action to be performed, whether an action should be performed, and/or the like. In some implementations, the model can be trained or updated. For example, flight management device 220 can use a machine learning technique, an artificial intelligence technique, and/or the like to update parameters of the model based on observations regarding questionable flight characteristics and corresponding performance (or non-performance) of actions.

In this way, flight management device 220 can take one or more actions based on a questionable flight characteristic. The actions taken, e.g., notifying one or more users and/or taking automatic actions, can be designed to facilitate safe operation of a UAV.

Although FIG. 4 shows example blocks of process 400, in some implementations, process 400 can include additional blocks, fewer blocks, different blocks, or differently arranged blocks than those depicted in FIG. 4. Additionally, or alternatively, two or more of the blocks of process 400 can be performed in parallel.

For example, in some implementations, flight management device 220 can perform portions of the process 400 after a flight has been approved and/or while a UAV is in flight. For example, flight management device 220 can, after a flight has been approved and a UAV is in the air, obtain an updated wind speed measurement, determine that the updated wind speed measurement is questionable based on at least one flight guideline, and send a notification to user device regarding the questionable wind speed characteristic.

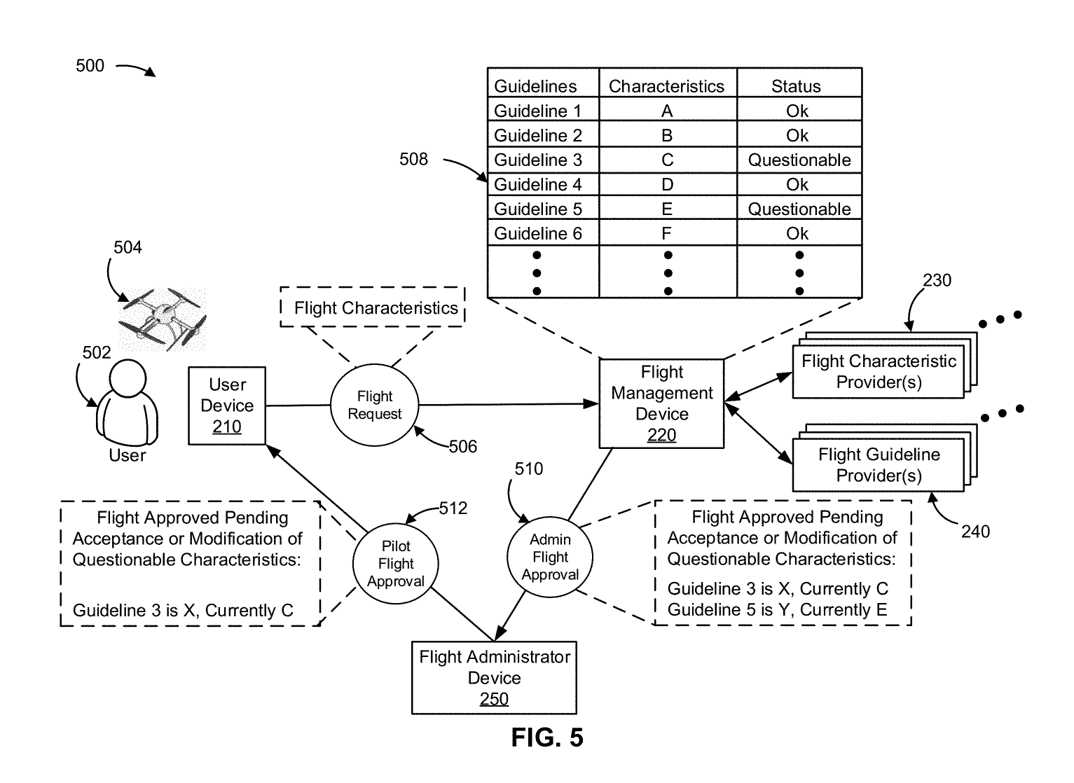

FIG. 5 is a flow diagram of an example data flow 500 for UAV flight management. FIG. 5 shows an example of user device 210, flight management device 220, flight characteristic provider(s) 230, flight guideline provider(s) 240, and flight administrator device 250.

As shown in FIG. 5, a user 502 interested in operating a UAV 504 can use user device 210 to send a flight request 506 to flight management device 220. The flight request 506 includes some flight characteristics, such as those provided by user 502, UAV 504 components, and/or user device 210. By way of example, the flight request 506 can include a first timestamp as a flight start time, a second timestamp for a flight end time, GPS coordinates indicating a proposed flight path of the UAV, and a user identifier.

Flight management device 220 can identify flight characteristics and flight guidelines relevant to the flight request 506. For example, flight characteristics can be identified from the flight request 506, flight characteristics can be provided by flight characteristic provider(s) 230, and/or flight characteristics can be identified from a storage device associated with flight management device 220. Flight guidelines can be obtained from flight guideline provider(s) and/or from flight guidelines stored in a storage device associated with flight management device 220.

As shown in the example data flow 500, flight management device 220 can generate a checklist 508 for determining whether flight characteristics are acceptable, unacceptable, or questionable. For example, the example checklist 508 indicates that characteristics C and E might be questionable, e.g., based on their corresponding guidelines: guidelines 3 and 5. The other guidelines are identified as acceptable, e.g., as indicated by the “Ok” status label. By way of example, guideline 3 might specify that an applicable pilot licensing guideline permits a pilot of UAV 504 to fly when visibility is no less than 4 kilometers. Characteristic C might be a visibility characteristic indicating current visibility of 4.5 kilometers. Flight management device 220 can determine that visibility is questionable based on how close 4.5 kilometers is to the 4 kilometers guideline. As another example, guideline 5 might specify that a UAV pilot employer guideline permits a UAV pilot to fly in public spaces up to 30 days after the UAV pilot's most recent flight. Characteristic E might be a flight characteristic that specifies that the pilot of the UAV 504 has had his/her most recent flight 28 days prior to the proposed flight time. Flight management device 220 can determine that the pilot's most recent flight is questionable based on how close 28 days is to the 30 day guideline.

In the example data flow 500, flight management device 220 provides administrator flight approval 510 to flight administrator device 250. The administrator flight approval 510 indicates that the proposed flight is approved, pending the acceptance or modification of questionable characteristics C and E, e.g., the administrator flight approval 510 specifies that the visibility guideline is 4 kilometers while the visibility characteristic is 4.5 kilometers and that the pilot's most recent flight guideline is 30 days while the pilot's most recent flight was 28 days prior. In the example data flow 500, flight administrator device 250 (e.g., automatically or based on user input) determines that the flight can proceed despite the questionability of the pilot's most recent flight, pending UAV pilot approval of the questionable visibility characteristic.

Pilot flight approval 512 sent to user device 210 from flight administrator device 250 can be similar to the administrator flight approval 510 provided to flight administrator device. In the example data flow 500, pilot flight approval 512 indicates to a UAV pilot that the flight is approved pending acceptance or modification of questionable characteristic C, e.g., the pilot flight approval 512 specifies that the visibility guideline is 4 kilometers while the visibility characteristic is 4.5 kilometers. In this example, a UAV pilot, e.g., user 502 operating UAV 504 and user device 210, can use the questionable characteristic and corresponding guideline to determine whether to proceed with the UAV flight.

As indicated above, FIG. 5 is provided merely as an example. Other examples are possible and can differ from what was described with regard to FIG. 5.

Some implementations of flight management device 220 described herein can improve safety, predictability, efficiency, and speed of approving UAV flights, relative to manual UAV flight approval processes. For example, speed can be improved by automating characteristic and guideline gathering and evaluation, as well as automating identification of questionable flight characteristics and automated actions taken in response to questionable flight characteristics. Efficiency can be improved by using fewer human resources to evaluable a flight request. Predictability can be improved by using automated or semi-automated processes for objectively identifying questionable characteristics. Safety can be improved by providing entities associated with a UAV flight with information that can be of use in determining whether a UAV flight is safe, e.g., by providing a UAV pilot or a pilot's supervisor with information that can be used to approve, delay, or cancel a proposed UAV flight in questionable conditions.

As used herein, the term component is intended to be broadly construed as hardware, firmware, or a combination of hardware and software.

Some implementations are described herein in connection with thresholds. As used herein, satisfying a threshold might refer to a value being greater than the threshold, more than the threshold, higher than the threshold, greater than or equal to the threshold, less than the threshold, fewer than the threshold, lower than the threshold, less than or equal to the threshold, equal to the threshold, or the like.

To the extent the aforementioned embodiments collect, store, or employ personal information provided by individuals, it should be understood that such information shall be used in accordance with all applicable laws concerning protection of personal information. Additionally, the collection, storage, and use of such information might be subject to consent of the individual to such activity, for example, through well known “opt-in” or “opt-out” processes as appropriate for the situation and type of information. Storage and use of personal information can be in an appropriately secure manner reflective of the type of information, for example, through various encryption and anonymization techniques for particularly sensitive information.

It will be apparent that systems and/or methods, described herein, can be implemented in different forms of hardware, firmware, or a combination of hardware and software. The actual specialized control hardware or software code used to implement these systems and/or methods is not limiting of the implementations. Thus, the operation and behavior of the systems and/or methods were described herein without reference to specific software code—it being understood that software and hardware can be designed to implement the systems and/or methods based on the description herein.

Even though particular combinations of features are recited in the claims and/or disclosed in the specification, these combinations are not intended to limit the disclosure of possible implementations. In fact, many of these features can be combined in ways not specifically recited in the claims and/or disclosed in the specification. Although each dependent claim listed below might directly depend on only one claim, the disclosure of possible implementations includes each dependent claim in combination with every other claim in the claim set.

No element, act, or instruction used herein should be construed as critical or essential unless explicitly described as such. Also, as used herein, the articles “a” and “an” are intended to include one or more items, and can be used interchangeably with “one or more.” Furthermore, as used herein, the term “set” is intended to include one or more items (e.g., related items, unrelated items, a combination of related and unrelated items, etc.), and can be used interchangeably with “one or more.” Where only one item is intended, the term “one” or similar language is used. Also, as used herein, the terms “has,” “have,” “having,” or the like are intended to be open-ended terms. Further, the phrase “based on” is intended to mean “based, at least in part, on” unless explicitly stated otherwise.

what is claimed is::

1. A device, comprising:
one or more processors to:
receive, from a user device, a flight request,
the flight request including at least one flight characteristic for an unmanned aerial vehicle (UAV) flight associated with the flight request;
identify flight characteristics associated with the flight request,
a flight characteristic, of the identified flight characteristics, specifying a characteristic of the UAV flight;
identify a flight guideline associated with the flight request,
the flight guideline specifying a limitation for at least one of the identified flight characteristics;
determine, based on the flight guideline, that one of the identified flight characteristics is a questionable flight characteristic; and
perform an action based on the questionable flight characteristic.

2. The device of claim 1, wherein the identified flight characteristics include at least one of:
a flight date, a flight time, a flight duration, a flight altitude, a flight origin location, a flight destination location, a flight path, a wind speed measurement, a humidity measurement, a temperature measurement, a precipitation measurement, a visibility measurement, a sunset time, a UAV model number, a UAV flight ceiling, a UAV weight, a UAV maximum payload, a UAV maximum wind speed, a UAV maximum operating temperature, a UAV minimum operating temperature, a UAV maximum communication range, a UAV maximum flight duration, a UAV maximum speed, a UAV noise level, a pilot certification, a pilot maximum operating wind speed, a pilot maximum flight operating duration, a pilot minimum operating visibility, a pilot maximum operating range, a most recent pilot flight, or career pilot hours.

3. The device of claim 1, wherein the one or more processors, when identifying the flight characteristics associated with the flight request, are to:
identify a flight characteristic included in the flight request;
obtain a flight characteristic from a data storage device; or
receive a flight characteristic from a flight characteristic provider device that is separate from the device.

4. The device of claim 1, wherein the one or more processors, when identifying the flight guideline associated with the flight request, are to:
obtain the flight guideline from a data storage device; or
receive the flight guideline from a flight guideline provider device that is separate from the device.

5. The device of claim 1, wherein the one or more processors, when identifying the flight characteristics associated with the flight request, are to:
identify multiple values for a particular flight characteristic; and
identify, based on the multiple values, a particular value for the particular flight characteristic.

6. The device of claim 1, wherein the one or more processors, when determining, based on the flight guideline, that one of the identified flight characteristics is a questionable flight characteristic, are to:
determine that the questionable flight characteristic is within a certain degree, measure, or percentage of satisfying or failing to satisfy the flight guideline.

7. The device of claim 1, wherein the one or more processors, when performing the action based on the questionable flight characteristic, are to:
provide the user device with data that causes display of information regarding the questionable flight characteristic.

8. A non-transitory computer-readable medium storing instructions, the instructions comprising:
a plurality of instructions that, when executed by one or more processors, cause the one or more processors to:
receive a flight request,
the flight request including at least one flight characteristic for an unmanned aerial vehicle (UAV) flight associated with the flight request;
identify, based on the flight request, flight characteristics associated with the UAV flight,
a flight characteristic, of the identified flight characteristics, specifying a characteristic of the UAV flight;
identify, based on the flight request, a flight guideline associated with the UAV flight,
the flight guideline specifying a limitation for a particular flight characteristic of the identified flight characteristics;
determine, based on the flight guideline and the particular flight characteristic, that the particular flight characteristic is a questionable flight characteristic; and
perform an action based on the questionable flight characteristic.

9. The non-transitory computer-readable medium of claim 8, where one or more instructions, of the plurality of instructions, that cause the one or more processors to identify, based on the flight request, the flight characteristics associated with the UAV flight, cause the one or more processors to:
identify a first flight characteristic from the at least one flight characteristic included in the flight request; and
obtain, from a flight characteristic provider, a second flight characteristic based on the first flight characteristic.

10. The non-transitory computer-readable medium of claim 8, where one or more instructions, of the plurality of instructions, that cause the one or more processors to identify, based on the flight request, the flight guideline associated with the UAV flight, cause the one or more processors to:
identify a first flight characteristic from the at least one flight characteristic included in the flight request; and
obtain, from a flight guideline provider and based on the first flight characteristic, the flight guideline.

11. The non-transitory computer-readable medium of claim 8, where one or more instructions, of the plurality of instructions, that cause the one or more processors to identify, based on the flight request, the flight characteristics associated with the UAV flight, cause the one or more processors to:
obtain, from a flight characteristic provider and based on the flight guideline, the particular flight characteristic.

12. The non-transitory computer-readable medium of claim 8, where one or more instructions, of the plurality of instructions, that cause the one or more processors to perform the action based on the questionable flight characteristic, cause the one or more processors to:
provide a flight administrator device with data that causes display of the questionable flight characteristic, the flight administrator device being separate from the device.

13. The non-transitory computer-readable medium of claim 8, where one or more instructions, of the plurality of instructions, that cause the one or more processors to perform the action based on the questionable flight characteristic, cause the one or more processors to:
obtain, from a flight characteristic provider, a new value for the questionable flight characteristic.

14. The non-transitory computer-readable medium of claim 8, where one or more instructions, of the plurality of instructions, that cause the one or more processors to perform the action based on the questionable flight characteristic, cause the one or more processors to:
cause the UAV to perform an action.

15. A method comprising:
receiving, by a device, at least one flight characteristic for an unmanned aerial vehicle (UAV) flight;
identifying, by the device, a flight characteristic associated with the UAV flight, the flight characteristic specifying a characteristic of the UAV flight;
identifying, by the device, a flight guideline associated with the UAV flight, the flight guideline specifying a limitation for the flight characteristic;
determining, by the device and based on the flight guideline and the flight characteristic, that the flight characteristic is a questionable flight characteristic; and
performing, by the device, an action based on the questionable flight characteristic.

16. The method of claim 15, further comprising:
logging data associated with the UAV flight.

17. The method of claim 16, further comprising:
determining, based on the data logged for the UAV flight, a questionability threshold for the flight guideline and a corresponding flight characteristic, the questionability threshold identifying a certain degree, measure, or percentage to which a corresponding flight characteristic needs to satisfy the flight guideline to be identified as a questionable flight characteristic.

18. The method of claim 15, wherein the determining, based on the flight guideline and the flight characteristic, that the flight characteristic is a questionable flight characteristic includes:
making the determination while the UAV is in flight.

19. The method of claim 15, wherein performing the action based on the questionable flight characteristic includes:
performing the action while the UAV is in flight.

20. The method of claim 15, wherein performing the action based on the questionable flight characteristic includes:
providing the UAV with instructions that cause the UAV to perform an action.
